(19) United States
(12) Patent Application Publication
(10) Pub. No.: US 2010/0205813 A1
(43) Pub. Date: Aug. 19, 2010

(54) ICE-AXE SHAFT EQUIPPED WITH A GRIP WITH AN ADJUSTABLE FINGER BRACE

(75) Inventors: Pierre PLAZE, Chambery (FR); Paul PETZL, Barraux (FR)

Correspondence Address: OLIFF & BERRIDGE, PLC, P.O. BOX 320850, ALEXANDRIA, VA, 22320-4850, US

(73) Assignee: ZEDEL, CROLLES (FR)

(21) Appl. No.: 12/707,033

(22) Filed: Feb. 17, 2010

(30) Foreign Application Priority Data
Feb. 17, 2009 (FR) 09 00721

(51) Int. Cl. B26B 23/00

(52) U.S. Cl. 30/308.1

(57) ABSTRACT

An ice-axe gripping shaft comprising a grip made from plastic material, equipped with a stop for the user's hand to rest against, and an intermediate finger brace for positioning the user's finger, Adjustment means of the finger brace comprise a locking lever articulated on the finger brace, and a plurality of notches staggered at regular intervals along a positioning zone to form a rack. The locking lever is equipped with a cam designed to engage in the locked position in one of the notches to immobilize the finger brace in a predefined adjustment position.

### BACKGROUND OF THE INVENTION

The invention relates to an ice-axe gripping shaft comprising a grip made from plastic material equipped with a stop for the user's hand to rest against, an intermediate finger brace for positioning the user's finger, and means for adjusting the finger brace along a positioning zone of the shaft.

### STATE OF THE ART

The way the shaft of an ice-axe is gripped in the alpinist's hand constitutes an essential factor for efficiency of penetration of the ice-axe into the ice. The alpinist generally holds the end of the shaft so as to obtain the greatest striking moment to achieve an optimum penetration force of the ice-axe into the ice. Such an ice-axe is generally used as a traction pick devoid of an attachment strap for extreme climbing, ice cascades and competition. Ice-axe grips enabling the position of the bottom rest stop to be adjusted to the morphology of the user's hand have already been proposed. The document EP1533006 describes an adjustment end-piece fitted swivelling on the handling grip, whereas the patent document US 2006/0070248 provides a telescopic adjustment end-piece by addition of a certain number of spacers modifying the length of the grip part.

Opposite this bottom stop, it is also known to adjust the intermediate finger brace along the shaft between a bottom position and a top position. A screw simply has to be loosened to obtain a certain radial clearance, and the finger brace can then be slid to a given position, the screw lock-nut then being retightened to secure the finger brace in this position. Performing such an adjustment on site takes a long time, requires the use of tools, and does not enable positive locking of the finger brace to be achieved if the nut is insufficiently tightened.

### OBJECT OF THE INVENTION

The object of the invention consists in providing an ice-axe shaft having a grip with a finger brace that is adjustable without tools to suit the morphology of the user's grip.

The device according to the invention is characterized in that the adjustment means comprise a locking lever articulated on the finger brace and a plurality of notches staggered at regular intervals along the positioning zone to form a rack, said locking lever having a cam designed to engage in the locked position in one of the notches to immobilize the finger brace in a predefined adjustment position.

Adjustment of the finger brace is very quick, can be performed by the alpinist at any time on site, and does not require any tools. He simply has to actuate the locking lever to the unlocked position, slide the finger brace to the required position, and then return the lever to the locked position to relock the latter.

According to a preferred embodiment, the locking lever is inserted between two adjacent fingers of the finger brace, being mounted swivelling on a pivot-pin acting as assembly means of said fingers. The base of the finger brace is provided with a cut-out to be able to actuate the locking lever to the unlocked position.

According to one feature of the invention, the notches of the rack extend along a straight intermediate portion of the shaft, above the ergonomic curved part of the grip.

The finger brace is preferably in the form of an openable plastic clamp comprising a body with a U-shaped semi-open recess extended by the two adjacent fingers fixed to one another by the assembly means.

### BRIEF DESCRIPTION OF THE DRAWINGS

Other advantages and features will become more clearly apparent from the following description of an embodiment of the invention given for non-restrictive example purposes only and represented in the accompanying drawings, in which:

FIG. 1 is a perspective view of the end of the gripping shaft of an ice-axe equipped with an adjustable finger brace according to the invention;

FIG. 2 shows a perspective view of the shaft of FIG. 1 with the finger brace assembly means represented in exploded view;

FIG. 3 is a perspective view of the shaft of FIG. 1 before the finger brace has been inserted on the positioning zone of the shaft;

FIG. 4 is a vertical cross-sectional view of the shaft of FIG. 1, the finger brace locking lever being locked in a first predefined adjustment position along the positioning zone;

FIG. 5 shows a partial view of FIG. 4 after the locking lever has been released enabling the finger brace to slide along the positioning zone;

FIG. 6 is a vertical cross-sectional view of the shaft of FIG. 1, the finger brace locking lever being locked in a second predefined adjustment position along the positioning zone;

FIG. 7 represents a detailed view of the finger brace assembled and fitted on the shaft;

FIG. 8 is a cross-sectional view along the line 8-8 of FIG. 7.

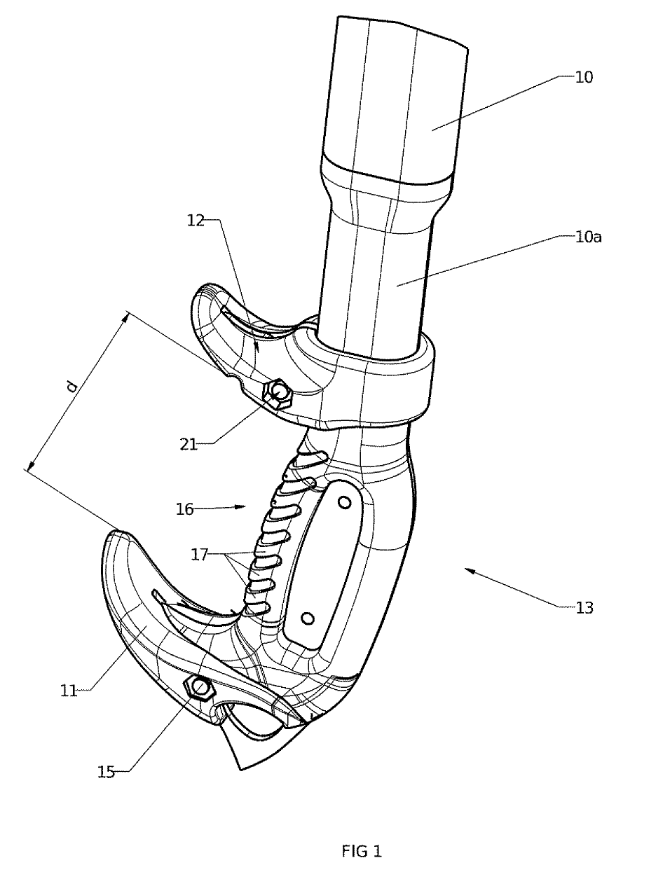

### DETAILED DESCRIPTION OF THE INVENTION

With reference to the figures, a gripping shaft 10 of an ice-axe comprises a grip 13 equipped with a stop 11 for the user's hand to rest against, and an intermediate finger brace 12 for positioning the user's finger. Such an ice-axe is generally used as a traction pick devoid of an attachment strap, for extreme climbing, ice cascades and competition.

Shaft 10 is preferably made from aluminum alloy and grip 13 is made from synthetic plastic material. It is bounded at the base of shaft 10 by stop 11 and finger brace 12 to protect the user's gloved hand to a great extent against shocks against the ice. Grip 13 can be overmolded on the end of shaft 10 or be secured to the latter by any other assembly method.

The incline of pressing stop 11 is advantageously adjustable at the bottom end of grip 13 so as to perform precise adjustment of the gap d occupied in the gripped state by the user's hand up to finger brace 12. Adjustment of the incline of stop 11 can be achieved either by screws 14 passing through staggered holes 15 of shaft 10, or by any other securing means, as described in the document EP1533006 filed by the applicant.

Between stop 11 and finger brace 12, grip 13 presents an ergonomic curved part 16 provided with a plurality of ribs 17 arranged on the same side as stop 11 to enhance gripping and adherence of the hand. This curved part 16 corresponds to the gripping area.

Finger brace 12 is in the form of an openable clamp comprising a body 18 with a U-shaped semi-open recess 20 extended by two adjacent fingers 19a, 19b. Body 18 is made from plastic material deformable by elasticity to enable it to be fitted along an intermediate portion 10a of shaft 10. This intermediate portion 10a of reduced cross-section is located above curved part 16 and determines an axial positioning zone ZP of finger brace 12.

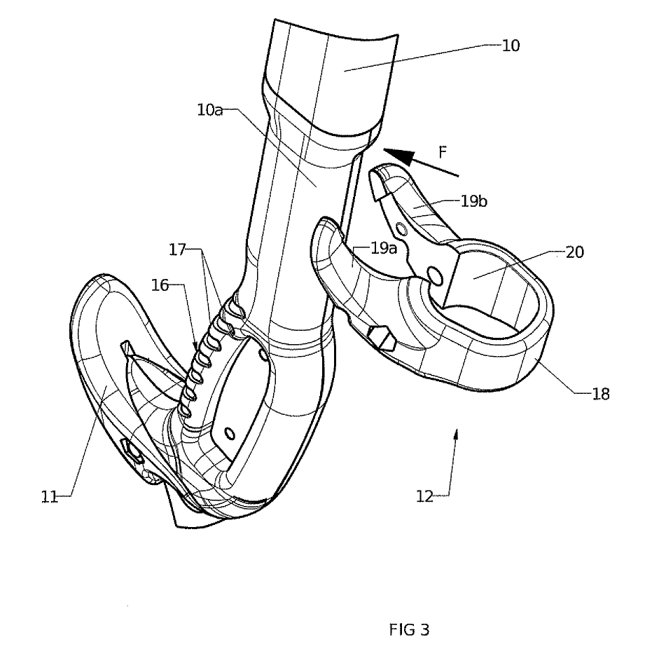

FIG. 3 shows finger brace 12 before the latter is inserted on intermediate portion 10a of shaft 10. The two fingers 19a, 19b are separated from one another to open recess 20 of body 18.

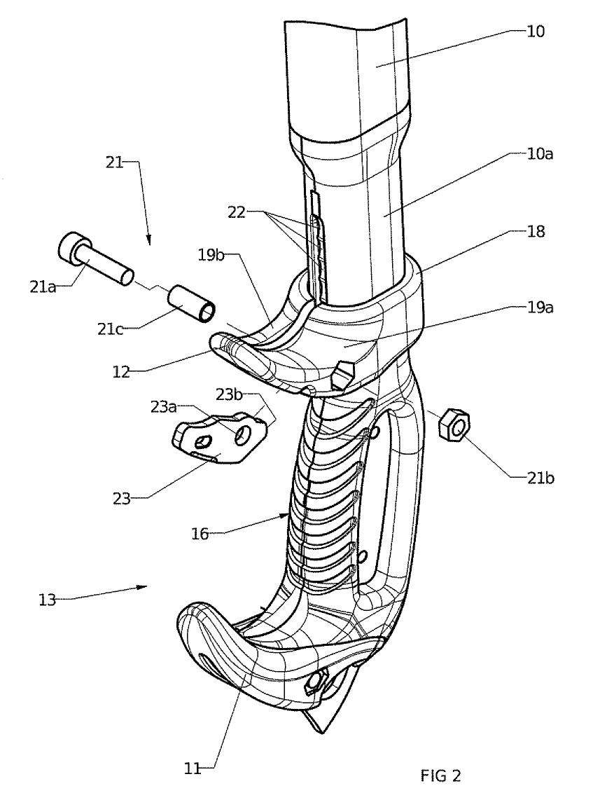

Finger brace 12 then simply has to be pushed in the direction of arrow F to achieve fitting thereof onto intermediate portion 10a (FIG. 2). The two fingers 19a, 19b are moved towards one another to form a single bearing surface that is curved slightly upwards. An assembly means 21 passes through aligned holes of the two fingers 19a, 19b to keep the latter in the non-separated position.

For example purposes, assembly means 21 of finger brace 12 are composed of a screw 21a, a nut 21b, and a tubular sleeve 21c fitted coaxially on the shank of screw 21a.

Straight intermediate portion 10a of shaft 10 is equipped with a series of adjustment notches 22 staggered at regular intervals in the heightwise direction to form a rack. A locking lever 23 is fitted between the two fingers 19a, 19b, being mounted swivelling on sleeve 21c of the assembly means acting as pivot-pin.

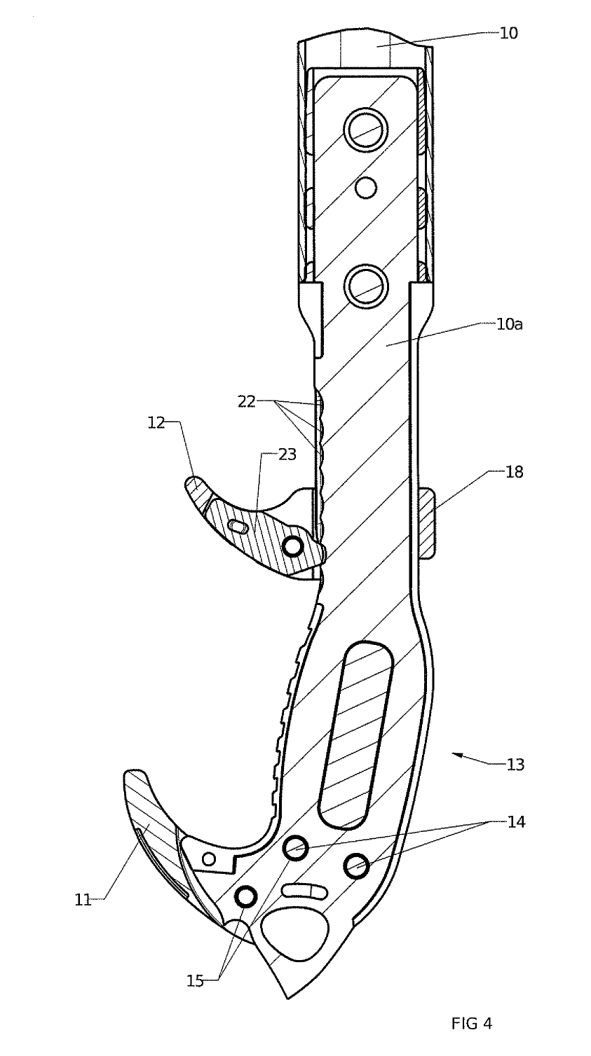

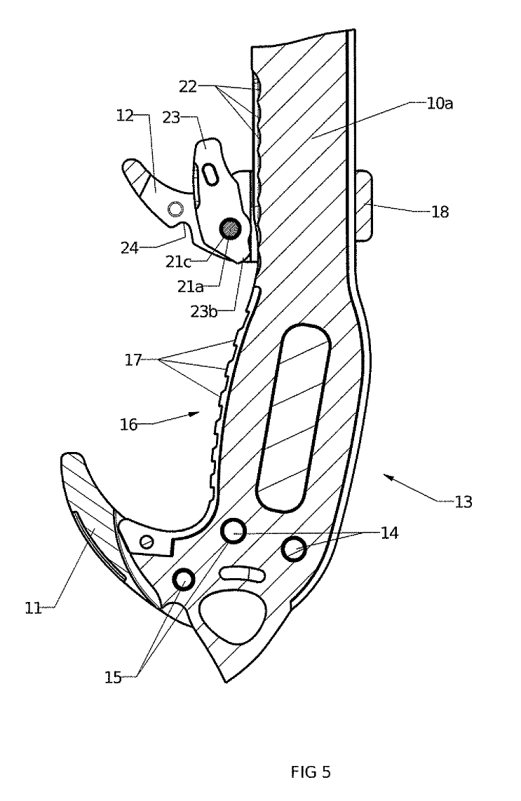

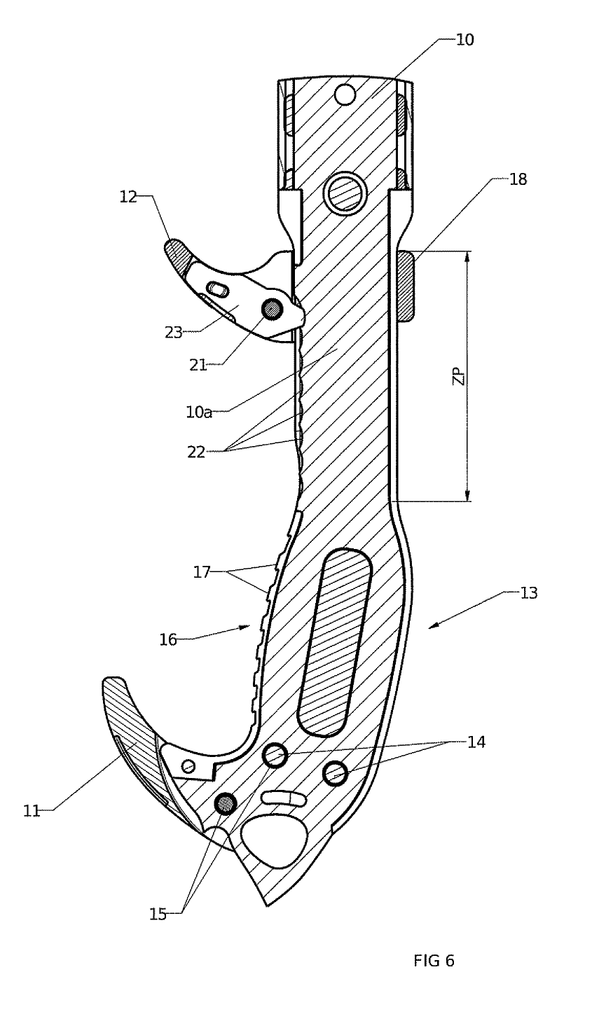

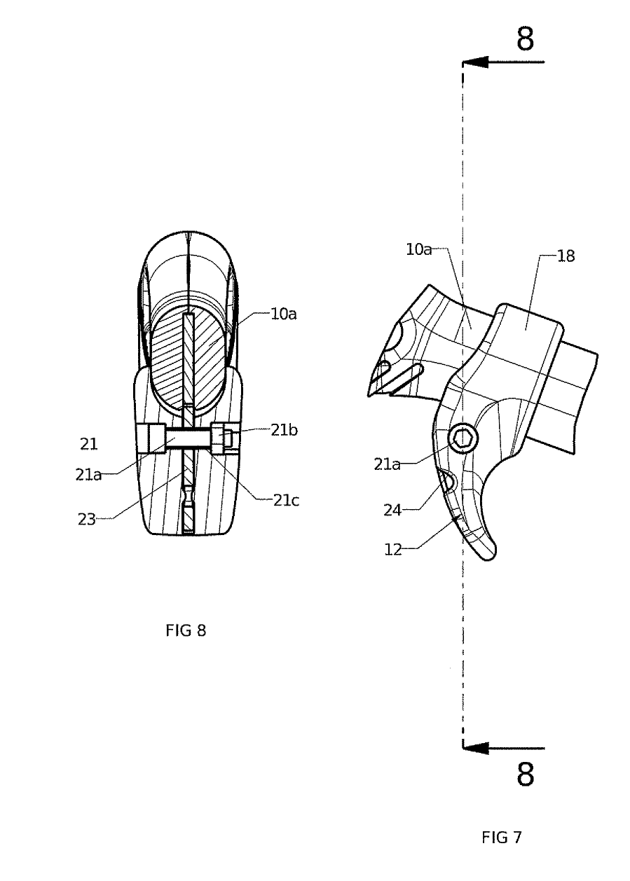

Locking lever 23 is provided with a circular hole 23a through which sleeve 21c passes, and with an end cam 23b designed to operate in conjunction with one of the notches 22 of the rack according to the required adjustment along positioning zone ZP. Locking lever 23 can be actuated manually between an unlocked position (FIG. 5) and a locked position (FIGS. 4 and 6).

In the unlocked position illustrated in FIG. 5, pivoting of swivelling lever 23 in the clockwise direction causes rocking of cam 23b releasing notches 22 of the rack. The radial clearance between recess 20 of body 18 and straight intermediate portion 10a of shaft 10 allows finger brace 12 to slide freely along positioning zone ZP.

After a predefined axial positioning of finger brace 12 has been chosen, locking lever 23 simply has to be pivoted in the counterclockwise direction to the locked position of FIG. 6. Cam 23b engages in one of the notches 22 of the rack and immobilizes finger brace 12 in this adjustment position. Locking lever 23 disappears totally in the gap separating two fingers 19a, 19b, without hampering the user's grip on finger brace 12.

Reverting from the locked position to the unlocked position is achieved by lifting locking lever 23 by means of a cut-out 24 arranged at the base of fingers 19a, 19b, opposite the gripping point of the user's finger.

FIG. 4 shows finger brace 12 locked in a first adjustment position that is the lowest possible position. Gap d available for gripping arranged between stop 11 and finger brace 12 is in this case minimum.

In FIG. 6, finger brace 12 is locked in a second adjustment position that is the highest possible position. Gap d available for gripping arranged between stop 11 and finger brace 12 is in this case maximum.

1. An ice-axe gripping shaft comprising:
a grip made of plastic material equipped with a stop for the user's hand to rest against, and with an intermediate finger brace for positioning a user's finger,
and adjustment means of the finger brace along a positioning zone of the shaft,
wherein the adjustment means comprise a locking lever articulated on the finger brace, and a plurality of notches staggered at regular intervals along the positioning zone to form a rack, said locking lever having a cam designed to engage in the locked position in one of the notches to immobilize the finger brace in a predefined adjustment position.

2. The ice-axe gripping shaft according to claim 1, wherein the locking lever (23) is fitted between two adjacent fingers (19a, 19b) of the finger brace (12), being mounted swivelling on a pivot-pin acting as assembly means (21) of said fingers.

3. The ice-axe gripping shaft according to claim 2, wherein the base of the finger brace is provided with a cut-out for actuating the locking lever to the unlocked position.

4. The ice-axe gripping shaft according to claim 2, wherein the locking lever is provided with a circular hole through which the pivot-pin of said assembly means of the fingers passes.

5. The ice-axe gripping shaft according to claim 1, wherein the notches of the rack extend along a straight intermediate portion of the shaft, above the ergonomic curved part of the grip.

6. The ice-axe gripping shaft according to claim 2, wherein the finger brace is in the form of an openable clamp made of plastic material comprising a body with a U-shaped semi-open recess extended by two adjacent fingers fixed to one another by the assembly means.

7. An ice-axe equipped with a gripping shaft with an adjustable finger brace according to claim 1.
